(19) United States
(12) Patent Application Publication
(10) Pub. No.: US 2026/0122716 A1
(43) Pub. Date: Apr. 30, 2026

(54) ONLINE ANOMALY DETECTION FOR ENERGY EFFICIENCY CONTROL IN CELL FREE WIRELESS COMMUNICATIONS NETWORK

(71) Applicant: British Telecommunications Public Limited Company, London (GB)

(72) Inventor: Manijeh BASHAR, London (GB)

(21) Appl. No.: 19/151,476

(22) PCT Filed: Jan. 9, 2024
(86) PCT No.: PCT/EP2024/050350

§ 371 Date: Jul. 28, 2025

(30) Foreign Application Priority Data
Feb. 1, 2023 (EP) 23154485.9

(51) Int. Cl. H04W 76/20; H04B 17/20; H04B 17/26; H04B 17/309; H04B 17/318; H04W 24/02

(52) U.S. Cl. CPC H04W 76/20; H04B 17/254; H04B 17/26; H04B 17/318; H04B 17/346; H04W 24/02

(57) ABSTRACT

The present disclosure relates to the optimization of user energy efficiency in Cell-Free Massive MIMO systems of the 6G mobile network. This is achieved by tracking the user's energy efficiency as a multi-variate time series and then utilizing an anomaly detection algorithm to detect if a user's energy efficiency drops to problematic levels. As a result of detecting an anomaly in the user's energy efficiency the algorithm can decide whether to support the user at a different frequency or access point, or that no remedial action is needed.

### PRIORITY CLAIM

The present application is a National Phase Entry of PCT Application No. PCT/EP2024/050350, filed Jan. 9, 2024, which claims priority from EP Application No. 23154485.9, filed Feb. 1, 2023, each of which is hereby fully incorporated herein by reference.

### TECHNICAL FIELD

The present disclosure generally relates to the optimization of the energy efficiency of users within a Cell-Free wireless communications system, by solving a plurality of problems relating to capacity maximization and long-term (LT) based capacity optimization.

The present disclosure further relates to anomaly detection algorithms that are used to detect when the energy efficiency of users within a Cell-Free wireless communications system fall to a level that is considered anomalous. The anomaly detection algorithms seek to improve the energy efficiency of users within the Cell-Free wireless communications system by providing remedial options should an anomalous drop in energy efficiency be detected.

### BACKGROUND

Cellular Massive Multiple Input Multiple Output (MIMO) is a viable solution for future wireless networks due to its capability to support high data rate transmission and massive connectivity with improved energy efficiency. However, the degraded data rate of cell-edge wireless devices remains a limiting factor and bottleneck problem in cellular Massive MIMO systems. The previously proposed network MIMO has been proposed to combat this problem. It is implemented in a network-centric approach, by dividing the access points (APs) into non-overlapping cooperation clusters in which the APs are sharing data to serve only mobile devices residing in the joint coverage area. However, this approach provides small gains in practice, and cannot completely remove the inter-cell/cluster interference. In Cell-Free Massive MIMO, distributed APs are connected to a CPU, and jointly serve distributed wireless devices. There are no cells and cell boundary concepts in Cell-Free Massive MIMO. All wireless devices in the network are coherently served by several distributed APs via a CPU.

FIG. 1 shows a system model of a cell-free massive MIMO system 1. With a very large number of distributed APs 10 through the area, there are always some APs close to each wireless device 12, that all relay data back to the CPU 14. This approach provides many of the benefits of a cloud radio access network (C-RAN), enjoying lower average path loss as well as distributed signal processing. Path loss is reduction in signal power and is influenced by the distance between the transmitter and the receiver. As a result, by removing the concept of “cell” and “cell-edge users”, Cell-Free Massive MIMO is promising system model as it provides all wireless devices with a great data rate service [1]. This approach allows for users to be supported by a plurality of access points which can be configured to serve a user as a user-centric cluster.

Huge demand for wireless data rate and number of devices which are connected to the access point has been observed in the last decades. With the dramatic growth of wireless devices (such as smart-phones, tablets, and laptops) and services/applications (such as real-time video streaming, video calls, watching high-quality movies, real-time games, Internet of Things, and remote controlling), the wireless data traffic will continue. Internet traffic was predicted to globally reach 235.7 Exabytes per month in 2021, confirming a huge increase compared to 2016 (up to 73.1 Exabytes per month) [1]. Moreover, there will be 11.6 billion mobile-connected devices, which corresponds to 1.5 devices per capita. On the other hand, with limited available wireless resources, including radio spectrum and transmit power, meeting higher data and Internet traffic requirements will only be possible through novel techniques and efficient resource utilizations. The transmit power of the wireless devices required to meet the corresponding data rate requirements with the conventional approaches will be significantly high. On the other hand, this increased power consumption will subsequently induce further issues such as extra CO2 emission resulting in climate changes. Energy efficient techniques are considered as one of the key avenues for addressing these issues in the development of future wireless systems.

The energy efficiency of cell-free massive MIMO systems has been investigated previously [2]-[5], including optimizing the transmit power of mobile users to improve the energy efficiency of the cell-free massive MIMO system. As such it has been shown that long-term (LT)-based capacity optimization can be solved by convex optimization toolbox. However, small-scale fading components change every few milli-seconds, and no solution is known for dealing with such small scale fading; there is therefore a need for investigation of energy efficiency of cell-free massive MIMO with respect to small-scale fading.

### SUMMARY

The present disclosure relates to the optimization of user energy efficiency in Cell-Free Massive MIMO systems such as proposed to be used in future 6G mobile telecommunications networks. This is achieved by tracking the user's small scale fading energy efficiency as a multi-variate time series and then utilizing an anomaly detection algorithm to detect if a user's small scale fading energy efficiency drops to problematic levels. As a result of detecting an anomaly in the user's small scale fading energy efficiency the algorithm can decide whether to take remedial action such as to support the user at a different frequency or access point, or that no remedial action is needed.

A first aspect of the disclosure provides a method for detecting an anomalous event in user energy efficiency in a cell-free wireless telecommunications network, the cell-free wireless telecommunications network comprising a plurality of access points configured to serve one or more users, wherein the method comprises: obtaining a transmission power for a user over a large-scale fading coherence time; whilst the user is transmitting, obtaining a time series of small scale fading instantaneous energy efficiency values relating to a small scale fading coherence time, wherein the small-scale fading coherence time is less than the large-scale fading coherence time such that multiple small scale fading instantaneous energy efficiency values are contained in the time series per large scale fading coherence time; identifying one or more anomaly periods of anomalous instantaneous energy efficiency values within the time series of small scale fading instantaneous energy efficiency values; and causing a reconfiguration of the user within the network in dependence on identification of the one or more anomaly periods of anomalous instantaneous energy efficiency values.

In other words, the method seeks to detect and mitigate against drops in user energy efficiency in a telecommunication network made up of a plurality of access points and users, wherein the telecommunications network is cell-free. The method sets each user a transmission power, or an optimum transmission power over a large-scale fading coherence time; during this transmission, the energy efficiencies of the user are monitored over a small-scale fading coherence time in order to obtain values of the user's instantaneous energy efficiency as a time series. Moreover, the small-scale fading coherence time is much less than the large-scale fading coherence time such that multiple small scale fading instantaneous energy efficiency values are contained in the time series per large scale fading coherence time. From the instantaneous energy efficiency values identifying one or more anomaly periods of anomalous instantaneous energy efficiency values within the time series of small scale fading instantaneous energy efficiency values i.e., sustained drops in instantaneous energy efficiency of the user. Then, reconfiguring the user within the cell-free wireless telecommunications network when one or more anomalous drops in instantaneous energy efficiency values has occurred.

According to the first aspect, wherein the identification of the one or more anomaly periods may further comprise: identifying a sustained drop in user energy efficiency indicative of an anomalous event; determining a length of the anomalous event; and comparing the length of the anomalous event with the small-scale coherence time and the large-scale coherence time.

Moreover, reconfiguring the user may comprise: determining that the length of the anomalous event is greater than the small-scale coherence time but smaller than the large-scale coherence time; and updating the user access point allocation to support the user with a different access point from the plurality of access points within the cell-free wireless telecommunications network. Further, the updating may occur within a large-scale coherence time period.

Also, reconfiguring the user may comprise: determining that the length of the anomalous event is greater than the large-scale fading coherence time and the small-scale fading coherence time; and updating the user frequency allocation to support the user in a different frequency band.

The method may further comprise: initializing a user at the start of each large-scale coherence time period, wherein the initializing may further comprise allocating a base station access point and a frequency band to the user.

Further, the small scale fading energy efficiency values may be based on the obtained transmission power.

The method may further comprise: optimizing the capacity of the cell-free wireless telecommunications network using large-scale fading components.

Moreover, the obtaining of the time series of small scale fading instantaneous energy efficiency values may further comprise monitoring the instantaneous energy efficiency of the user over the small scale fading coherence time.

Further, the identifying of the sustained drop in user energy efficiency indicative of an anomalous event may be achieved using a sub-sequence anomaly detection technique.

The sub-sequence anomaly detection technique may be a machine-learning algorithm which may have been trained on a plurality of example sustained drops in user energy efficiency indicative of anomalous events.

Moreover, the method may be performed for each user of a plurality of users. In other words, the method may be completed for each user of all the users in the cell-free wireless telecommunications network.

A second aspect of the disclosure provides a system for detecting anomalous events in user energy efficiency in a cell-free wireless telecommunications network having a plurality of users and access points, the system comprising: a processor; and a computer-readable medium having stored thereon computer executable instructions that when executed, trigger the processor to: calculate and fix a transmission power for a user using a large-scale fading components; calculate an instantaneous energy efficiency of the user using the fixed transmission power and a small-scale fading components; identify a sustained drop in user energy efficiency indicative of an anomalous event; determine a length of the anomalous event; and reconfigure the user based on the length of the anomalous event in comparison with a small-scale coherence time and a large-scale coherence time.

According to the second aspect, the processor may have access to at least the following information: the number of users, K, within the cell-free wireless telecommunications network; the number of access points, M, within the cell-free wireless telecommunications network; data indicative of the small-scale fading components; data indicative of the large-scale fading components; and the available frequency bands for communication within the cell-free wireless telecommunications network.

Moreover, the computer-readable medium may have further stored thereon: a sub-sequence anomaly detection technique that utilizes machine-learning techniques to identify sustained drops in user energy efficiency indicative of an anomalous event; and a series of long time series data containing a plurality of example sustained drops in user energy efficiency indicative of anomalous events for use in training the sub-sequence anomaly detection technique.

According to a further aspect of the disclosure, which provides a system for detecting anomalous events in user energy efficiency in a cell-free wireless telecommunications network having a plurality of users and access points, the system comprising: a processor; and a computer-readable medium having stored thereon computer executable instructions that when executed caused the processed to perform the method necessary for detecting anomalous events in user energy efficiency in a cell-free wireless telecommunications network having a plurality of users and access points.

According to a further aspect, a method is provided for use in a cell-free wireless telecommunications network, the cell-free wireless telecommunications network comprising a set of access points configured to cooperatively serve a user as a user-centric cluster, the method comprising: obtaining data indicating an energy efficiency time series for the user; identifying an anomaly in the energy efficiency time series for the user; determining a time duration of the identified anomaly; and reconfiguring the user based on a comparison of the determined time duration to a coherence time of the user.

According to the above further aspect, reconfiguring the user may comprise: determining that the determined time duration is greater than a coherence time of small-scale fading and less than a coherence time of large-scale fading, and, in response, updating a membership of the set of access points. Alternatively, reconfiguring the user may comprise: determining that the determined time duration is greater than a coherence time of large-scale fading, and, in response, reconfiguring a frequency of communications between the set of access points and the user.

Moreover, the membership of the set of access points may be updated within a current coherence time of large-scale fading.

In the above-mentioned method, the anomaly may be identified using a sub-sequence anomaly detection technique. Further, the above aspects may be performed for each user of a plurality of users.

Further features and advantages will be apparent from the appended claims.

### BRIEF DESCRIPTION OF THE DRAWINGS

Further features and advantages of the present disclosure will become apparent from the following description of an embodiment thereof, presented by way of example only, and with reference to the accompanying drawings, wherein like reference numerals refer to like parts, and wherein:

FIG. 1 shows a system diagram of a cell-free massive MIMO.

FIG. 2 shows a diagram depicting the relationship between the time period T_{LSF} of large scale fading and the time period T_{SSF} of small scale fading for an outdoor scenario at a frequency of 2 GHz.

FIG. 3 shows an example graph of instantaneous energy efficiency of the system as a multi-variate time series, for K=4 users.

FIG. 4 shows an example graph of subsequence anomaly detection for three univariate time series', related to K=3 users.

FIG. 5 shows a proposed flow diagram for the online anomaly detection algorithm of energy efficiency in cell-free mobile networks.

FIG. 6 shows a block diagram of a computer system for use with the CPU.

### DETAILED DESCRIPTION

The present disclosure seeks to track the trends and values of the multi-variate time series of instantaneous energy efficiencies to detect the presence of an anomalous event that causes a problematic drop in the user energy efficiency. Mitigating against drops in prolonged energy efficiency is important in a plurality of different ways such as to improve the battery life in the downlink system or to reduce the required size of electronics, improve the bandwidth requirements or meet regulatory standards in the uplink system.

In particular the present disclosure monitors the instantaneous energy efficiency of user terminals of a cell-free network over each coherence interval of small scale fading, and forms a time series of such small scale fading measurements, at a temporal resolution of the small scale fading coherence interval (which for a 2 GHz signal is about 1/120^{th} of the large-scale fading coherence interval, although this relationship is frequency dependent). The time series of small scale energy efficiencies is then monitored using one or more anomaly detection algorithms (which independently may themselves be known per se in the art for detecting anomalies in time series data) to identify periods in the series when the small scale energy efficiency of a user terminal in the network is low, and remedial action is then taken. Relevant remedial action that might be taken includes switching the user terminal to a closer access point, for example.

There follows a description of an embodiment of the present disclosure. The description first presents the theoretical and mathematical background of the embodiment, and including a brief description of the energy efficiency anomaly detection method that has been developed. A further more detailed description of the embodiment is then undertaken again, this time with respect to the Figures, where further details of the operation of the developed method when in use will be provided.

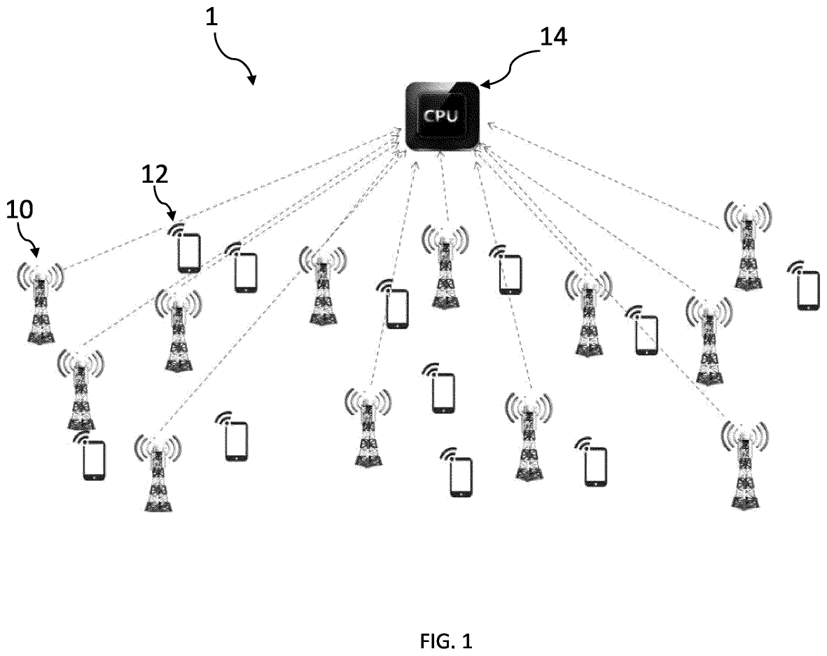

FIG. 1 shows the general operating environment of embodiments of the present disclosure. Here, a cell-free network 1 is provided, which has a managing server 14, referred to in the diagram and below as CPU 14, and plural access points (APs) 10, that are controlled by the managing server (CPU) 14. Plural mobile terminals 12 (which may be user handsets, or may be any other suitably equipped devices that can register to and use the cell-free network. For example, it is already known in the art that many different types of devices can be equipped with SIM cards to allow independent access to mobile networks for reporting and monitoring purposes. Moreover, whilst within the present disclosure the units 10 are occasionally referred to as “base stations (BS)”, more generally it should be understood that in the context of the present disclosure the units 10 can more generally also be described as access points (APs 10), providing network access point functionality to the cell free network without requiring all of the components and functions of a base station.

Within the cell-free network 1, it is not necessarily the case that a mobile terminal 12 will necessarily communicate with its closest access point 10, as is usually the case in a cellular network. Instead a mobile terminal 12 may communicate with any of the access points 10, and instead it is the energy efficiency of the different links that cause the connections to be optimized, as will be described.

### Available Information at the CPU

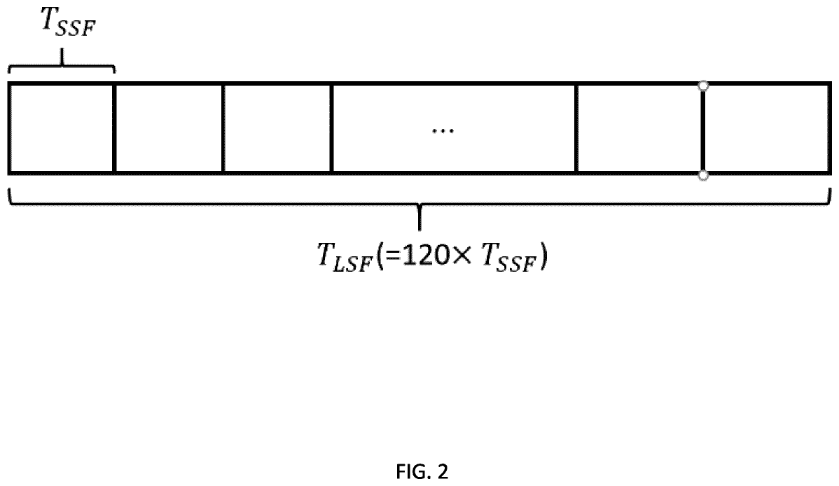

The spatial wide-sense stationary (WSS) property is defined as [6]:

$${Q}_{WSS} = \frac{{T}_{LSF}}{{T}_{SSF}} , \qquad ( 1 )$$

where T_{LSF} refers to the coherence time of large-scale fading (LSF), where the large-scale fading channel may be considered constant within this interval, whereas T_{SSF} is the channel coherence time of small-scale fading channel [6]. The measurement results for an outdoor scenario at a frequency of 2 GHz shows that Q_{wSS}=120 [6]. As a result, any optimization algorithm which is defined based on the long-term time T_{LSF} needs to be run every 120T_{SSF}, while the any coherence time T_{SSF}-based optimization algorithm needs to be solved at the beginning of each coherence time. As a result, only LSF-based optimization algorithms are practical in real-time systems. The relationship between T_{LSF} and T_{SSF} is shown in FIG. 2.

The LSF components are a function of positions of users, position of APs, and shadowing. As all M APs and K users are distributed in the area, we will have a M*K matrix for the LSF components. The CPU 14 exploits long term correlation of channel state information to calculate the LSF. So, it is common to assume that the LSF components are known at the CPU 14 [1].

### Long-Term (LT)-Based Capacity Optimization Problem

A capacity maximization problem for cell-free massive MIMO is defined below.

$${max}_{{p}_{k}} {C}_{k}^{LSF} , \qquad ( 2 )$$

$$0 \leq {p}_{k} \leq {p}^{available} , 1 \leq k \leq K$$

$$where {C}_{k}^{LSF}$$

is the capacity of the kth user, when only the long-term information (large-scale fading channel information) are available at the CPU, pₖ refers to the allocated power to the kth user, and p^{available} is the maximum available power at each user. Finally, K is the total number of users in the system.

Note that as the complexity of solving this optimization problem in cell-free massive MIMO is very high, it is not feasible to define an optimization problem as a function of small-scale fading as the coherence time of small-scale fading is too small and there is no time to solve the optimization problem (2). Then we use long term information (large-scale fading information) to define the capacity optimization problem. Note that after solving the optimization problem (2), the

$${p}_{k}^{*} ,$$

1≤k≤K.

### Energy Efficiency of the System

The uplink power consumption can be defined as transmit power at the wireless mobile stations. Energy efficiency maximization is defined as getting the same data rate while consuming “less power”. In this section, we define the instantaneous energy efficiency of the system as a function of the coherence time of instantaneous small-scale fading T_{SSF} of the system.

For each SSF interval, we generate an instantaneous channel for user k as:

$${Channel}_{k}^{SSF} .$$

Then we can calculate the instantaneous capacity

$${C}_{k}^{SSF} .$$

Finally, the instantaneous energy efficiency is calculated as

$${EE}_{k}^{SSF} = \frac{{C}_{k}^{SSF}}{{p}_{k}} .$$

The instantaneous energy efficiency of the kth user is given by

$${EE}_{k}^{SSF} = \frac{{C}_{k}^{SSF}}{{p}_{k}^{*}} , 1 \leq k \leq K , \qquad ( 3 )$$

$$where {C}_{k}^{SSF}$$

is the capacity of the kth user using the small-scale fading at the CPU. Note that the small-scale fading is available at the CPU for data decoding. Convex optimization is a mathematical optimization algorithm which can be used to solve the LSF-based capacity optimization problem [2]-[5]. In the LSF-based capacity optimization problem, the power elements are the optimization variables. Then one could define the optimization problem as a convex problem, where the programming CVX toolbox is used to solve the optimization problem [2]-[5].

On the other hand, the following optimization problem can be solved [2]:

$${P}_{1} : {max}_{{p}_{k}} {EE}_{k}^{LSF} , \qquad ( 4 )$$

$$0 \leq {p}_{k} \leq {p}^{available} , 1 \leq k \leq K$$

However, note that the LSF-based energy efficiency

$${EE}_{k}^{LSF}$$

cannot guarantee any lower bound on the SSF-based energy efficiency

$${EE}_{k}^{SSF} . Then {EE}_{k}^{SSF}$$

needs more investigation.

$${EE}_{k}^{SSF}$$

has not been investigated in the art because it is not feasible due to the small coherence time SSF components.

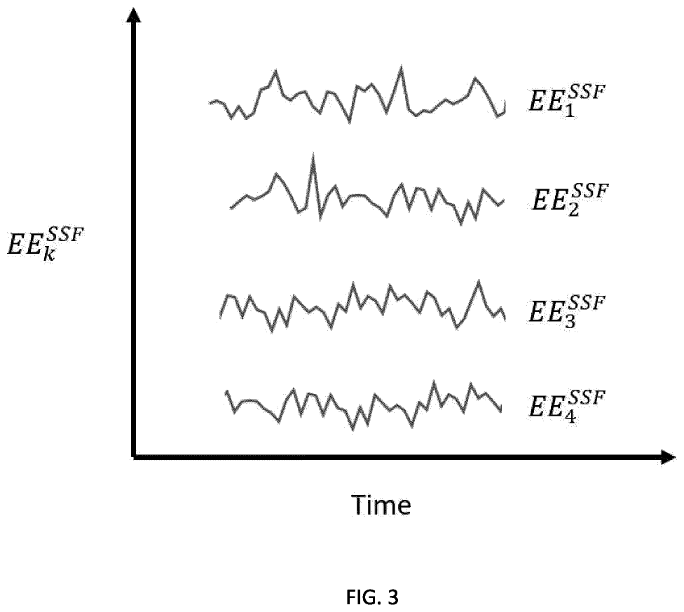

Next, the energy efficiency of the users is defined as a time series. FIG. 3 represents an example of instantaneous energy efficiency of the system for K=4 users as multi-variate time series.

### Online Anomaly Detection Algorithm for Energy Efficiency

Herein we investigate the instantaneous energy efficiency of the system based on the assumption that the pk*, 1≤k≤K is fixed during T_{LSF}, which is equivalent to 120×TSSF (based on (2)). As a result, after solving the capacity maximization problem (2), the uplink power of the users, i.e., pk*, 1≤k≤K, is fixed during the coherence interval of LSF. On the other hand, the instantaneous channel is fixed only during each coherence interval of SSF. This means that the instantaneous energy efficiency of the users changes at the end of each coherence interval of SSF. So, there is no way to control the instantaneous energy efficiency of the users with fixed uplink power pk*, 1≤k≤K. Hence, we propose a practical algorithm which can analyze the instantaneous energy efficiency of users and is feasible for each short coherence interval of SSF.

In this section, we propose to perform a time series anomaly detection on the performance of the energy efficiency of the system. Note that it is not practical to optimize the energy efficiency of the system during the coherence time of SSF, as it is too short. Therefore, performing online anomaly detection on the multi-variate time series of energy efficiency of the system is a practical scheme to investigate the behavior of energy efficiency of multiple users at the same time. If there is an anomaly on the energy efficiency of a user, the user needs to be supported by a different group of APs or in another frequency band.

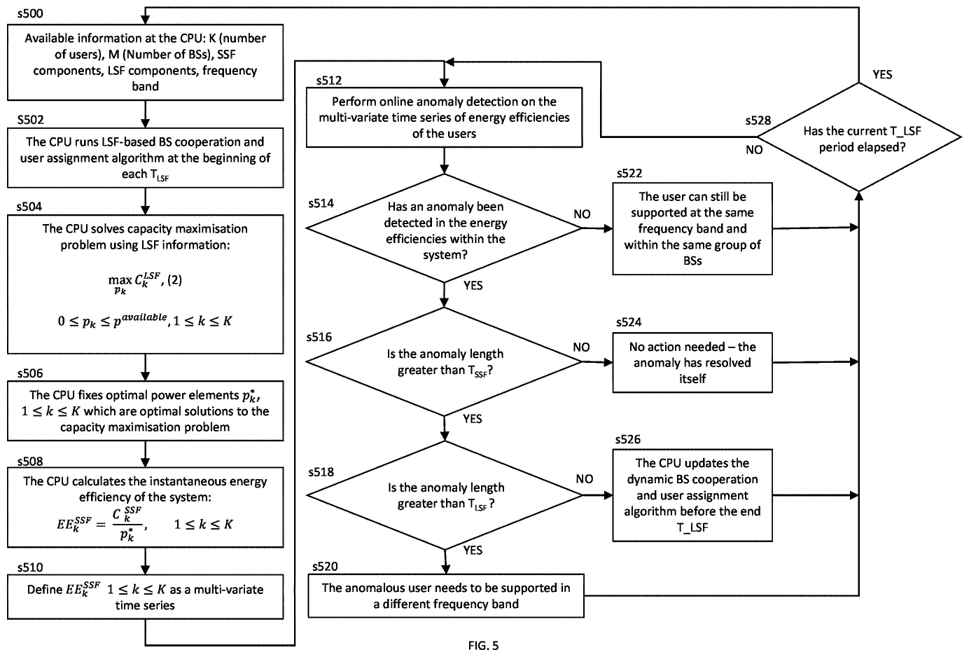

FIG. 5 shows the proposed diagram for online anomaly detection of energy efficiency of the cell-free mobile networks. At the beginning of each time slot of LSF, the CPU runs AP cooperation and user assignment algorithm, and accordingly solves the LSF-based capacity maximization problem [1]. We then suggest that the CPU calculates the SSF-based energy efficiency of the system and performs an online anomaly detection algorithm on this data, as described further later. Note that if the length of anomalies (La) are smaller than TSSF, there is no chance that the anomalies are due to the mobilities or change in the environment. If the length of anomalies is larger than TSSF, then it might be because of mobilities or change in the environment (which causes change in LSF). As a result, if the length of anomalies are bigger than TSSF, the operator can ask the CPU to update the dynamic AP cooperation and user assignment algorithm before the end of coherence time of LSF, i.e., TLSF. So, in this case, the CPU should not wait for the next coherence time of LSF, and the AP cooperation and user assignment set-ups need to be updated earlier and with some extra constraints. These constraints can be number of APs which support the anomaly users. For example, we can increase number of APs which support the anomaly users. However, if the length of anomalies is bigger than TLSF, updating AP cooperation and user assignment algorithm cannot solve the problem with anomalies, and hence the anomaly users need to be supported in a different frequency band.

Please note that we propose to store a very long time series data in the CPU. Then the anomaly detection algorithm exploits this long time series data for training. Hence, once the algorithm is trained, one can run online anomaly detection on the stored data. This means that as soon as the data is arrived, the algorithm identifies the received data as either anomaly or non-anomaly. Finally, at each time the algorithm compares La (length of anomaly) with LSSF and LLSF.

### Decision Making

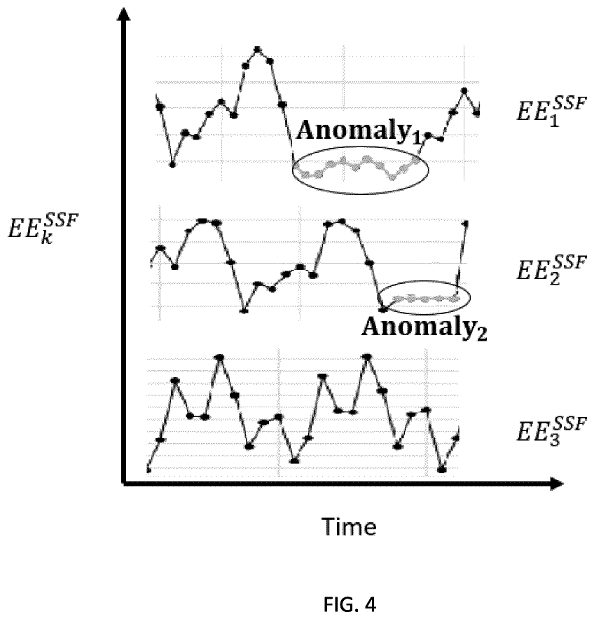

As a reminder, we propose to model the energy efficiency as multivariate time series. As we are interested in the individual energy efficiency of all K users (given in equation (3)), it would be sufficient to run anomaly detection schemes individually (and simultaneously) on each time series. On the other hand, as explained above in the proposed algorithm, we are interested in the anomalies with length LSSF<<La<<LLSF. As a result, the most suitable anomaly detection algorithms are the ones which are designed to investigate “subsequence anomalies” in univariate time series data. FIG. 4 represents an example of subsequence anomaly detection for 3 univariate time series (related to energy efficiency performance of 3 users), where two subsequence anomalies are found (Anomaly1 and Anomaly2, related to user 1 and user 2, respectively). Finally, as stated in FIG. 5, the operator needs to look at the length of subsequence anomalies (La) and compare it with LSSF and LLSF to make the correct decision after finding the subsequence anomalies.

One of the algorithms which is suitable for training can be long short-term memory (LSTM), which is a non-supervised deep learning algorithm for anomaly detection in time series [8]. There are few hyperparameters which need to be set in advance. The first set of parameters are hyperparameter related to training the model. Learning curve is used to see how training error increases and validation error decreases as we increase the training sizes. For example, the hyperparameter can be considered as batch-size=500 and number of epochs=5 and regularization=10-6. Please note that these hyperparameters need to be tuned based on the learning curve. One can train the model and process the learning curve to check the effect of hyperparameter. Moreover, in LSTM training, we resize our data for feeding with a window size (Lwindow). The window size of LSTM should be comparable with LSSF and LLSF. We advise to use Lwindow=LLSF. For example, if LSSF is big enough to transmit 100 data samples from mobile users, we advise to set Lwindow=100.

Further details of the arrangements of the present disclosure will become apparent from the following detailed description made with respect to the Figures.

Firstly, FIG. 2 depicts the coherence time relationship between the coherence time of the small scale fading and the coherence time of the large scale fading. It is worth noting that the coherence time is the minimum time duration over which the channel impulse response is considered to not be changing. Thus, the large-scale fading coherence time can be defined as the time period in which the channel characteristics are sufficiently stable i.e., considered to not be changing, such that when a signal is processed for transmission based on these channel characteristics then they are received at a satisfactory quality (e.g. error rate<threshold). Therefore, from FIG. 2 it can be seen that T_{SSF} is much shorter than the T_{LSF} and as indicated by the equation in FIG. 2 the T_{SSF} is approximately 120 times shorter that the T_{LSF} at a frequency of 2 GHz, in an outdoor scenario. Further, it is worth highlighting that the small scale fading is used to detect and describe signal levels at the receiver or AP that are of a small nature such as several wavelengths or smaller. These signals could relate simply to the user moving a mobile phone (the transmitter) in their hands for example. Large scale fading is used to detect and describe signal levels at the receiver or BS that are of a larger nature such as tens or hundreds of wavelengths or more. These signals could relate simply to the user walking significant distances whilst holding a mobile phone (the transmitter).

Embodiments of the present disclosure seek to balance the spatial wide-sense stationary (WSS) property which is given in (1), In (1), where T_{LSF} refers to the coherence time of large-scale fading (LSF), where the large-scale fading channel may be considered constant within this interval, whereas T_{SSF} is the channel coherence time of small-scale fading channel [6]. The measurement results for an outdoor scenario at a frequency of 2 GHz shows that QWSS=120 [6]. As a result, any optimization algorithm which is defined based on the long-term time T_{LSF} needs to be run every 120T_{SSF}, while any coherence time T_{SSF}-based optimization algorithm needs to be solved at the beginning of each coherence time. As a result, only LSF-based optimization algorithms are practical in real-time systems [6]. This embodiment simultaneously seeks to maximize the capacity maximization problem given in equation (2) above and maximize the optimization problem given in equation (4) above.

FIG. 3 shows an example graph depicting the instantaneous energy efficiencies of users, K, in terms of small scale fading. As can be seen, the instantaneous energy efficiencies are shown as a multi-variate time series; it is clear from this that the instantaneous energy efficiencies of the users are constantly changing. Embodiments of the present disclosure seek to track the trends and values of the multi-variate time series of instantaneous energy efficiencies to detect the presence of an anomalous event that causes a problematic drop in the user energy efficiency. Mitigating against drops in prolonged energy efficiency is important in a plurality of different ways such as to improve the battery life in the downlink system or to reduce the required size of electronics, improve the bandwidth requirements or meet regulatory standards in the uplink system. FIG. 4 shows an example graph, again, depicting the instantaneous energy efficiencies of three users. In this graph it can be seen that two anomalies in the user's energy efficiencies have been detected, Anomaly₁ and Anomaly₂. These are shown in FIG. 4 through prolonged drops in the user's energy efficiency.

FIG. 5 shows a flow diagram of the algorithm that is used to achieve the LSF-based AP cooperation, user assignment algorithm and the anomaly detection algorithm of the present embodiment. The flow diagram starts at s500 where the available information at the CPU is collected, this includes the number of users, K, the number of access points, M, the small scale fading components, the large scale fading components and the frequency bands. At s502 the CPU runs the LSF-based access point cooperation and user assignment at the beginning of each large scale fading coherence time period, which is discussed in more detail above. In s504 the CPU solves the capacity maximization problem using LSF information for each of the users. The capacity maximization problem, as stated above, is defined by the following:

$${max}_{{p}_{k}} {C}_{k}^{LSF} , \qquad ( 2 )$$

$$0 \leq {p}_{k} \leq {p}^{available} , 1 \leq k \leq K$$

where Cₖ^{LSF} is the capacity of the kth user, when only the long-term information (large-scale fading channel information) are available at the CPU, pk refers to the allocated power to the kth user, and p^{available} is the maximum available power at each user. Finally, K is the total number of users in the system.

As mentioned previously, as the complexity of solving optimization problem in cell-free massive MIMO is very high, it is not feasible to define an optimization problem as a function of small-scale fading as the coherence time of small-scale fading is too small and there is no time to solve the optimization problem (2). Then we use long term information (large-scale fading information) to define the capacity optimization problem. Note that after solving the optimization problem (2), the pₖ*, 1≤k≤K. In s506, once the CPU has completed the capacity maximization and found an optimal power, the CPU fixes the optical power element

$${p}_{k}^{*} , 1 \leq k \leq K$$

which are optimal solutions to the capacity maximization problem. In s508 the CPU then uses the fixed optimal power and the calculated capacity maximization to calculate the instantaneous energy efficiency of each user, K, in the system. The instantaneous energy efficiency of each user, K, is given as:

$${EE}_{k}^{SSF} = \frac{{C}_{k}^{SSF}}{{p}_{k}^{*}} , 1 \leq k \leq K$$

Next, in s510, the instantaneous energy efficiencies calculated in s508 are converted and defined as a multi-variate time series.

In s512, the CPU then begins online anomaly detection on the energy efficiency of the system. There are a plurality of different algorithms and sub-sequence anomaly detection technique that can be used to achieve the online anomaly detection such as unsupervised collective point machine-learning algorithms or supervised machine-learning algorithms. A more rudimental algorithm for example utilizing thresholding could also be used.

Further examples of known anomaly detection algorithms per se that can be applied as the anomaly detection algorithm in the present embodiment can be found below; however, this is not an exhaustive list, and many other options would be applicable. The main point and one of the contributions of the present disclosure is the application of such known anomaly detection algorithms per se into the problem domain of the present disclosure i.e. detecting anomalies in time series data of energy efficiency of small-scale fading in a cell-free wireless telecommunications system:
1) The authors in [9]propose an anomaly detection algorithm, which extends the recently developed FOCUS algorithm for online change detection to Poisson data. The algorithm is mathematically equivalent to searching over all possible window sizes, but at half the computational cost of the current grid-based methods. The authors demonstrate the additional power of the algorithm using simulations and data drawn from the Fermi gamma-ray burst catalogue.
2) An LSTM Autoencoder is an implementation of an autoencoder for sequence data using an Encoder-Decoder LSTM architecture. For a given dataset of sequences, an encoder-decoder LSTM is configured to read the input sequence, encode it, decode it, and recreate it. The performance of the model is evaluated based on the model's ability to recreate the input sequence [10]. Once the model achieves a desired level of performance recreating the sequence, the decoder part of the model may be removed, leaving just the encoder model. This model can then be used to encode input sequences to a fixed-length vector. The resulting vectors can then be used in a variety of applications, not least as a compressed representation of the sequence as an input to another supervised learning model [10].
3) In [11], the authors present an introduction of an inference procedure that allows for the identification of Collective And Point Anomalies (CAPA). Then, it establishes finite sample consistency results not only for CAPA, but also for a commonly used penalized cost based method aimed at detecting changes in mean and variance. This setting presents significant additional technical challenge compared to the change in mean setting, to which most existing theoretical results apply.

Irrespective of the method or algorithm used for anomaly detection, the CPU will continue to attempt to classify any potential anomalies in user energy efficiency and then action the required response to prevent a significant or prolonged drop in overall energy efficiency. In s514, the CPU will undertake a decision of whether an anomaly in the energy efficiency of the user's within the system has occurred. As noted above, this assessment can be performed using any one or more of several known data series anomaly detection methods. If the answer is no and no anomaly has been detected then the algorithm will move to s522 where no action is required as the user is operating as expected. Therefore, the user can still be supported at the current frequency band and within the same group of access points. In this case the algorithm will move to s528 (discussed below). If the answer at s514 is yes, then an anomaly of some extent has been detected and the algorithm will move on to s516.

At s516, the CPU will decide whether the detected anomaly has an anomaly length (time or sequence of time points) greater than T_{SSF} or the small-scale fading coherence time. If the answer is no and as such the detected anomaly has an anomaly length smaller than T_{SSF} then the algorithm will move to s524. In s524, no action is required as the anomaly has appeared to correct itself or it was of such a short time period that it requires no action to rectify as such the algorithm will move to s528. If the answer at s516 is yes, then the algorithm has determined that the detected anomaly has an anomaly length greater than T_{SSF} and as such the algorithm will move onto s518.

At s518, the CPU will decide whether the detected anomaly with an anomaly length greater than T_{SSF} is also greater than T_{LSF}, or the large-scale fading coherence time. If the answer is no, then the CPU has detected an anomaly that has the following characteristics: T_{SSF}≤Lₐ≤T_{LSF} i.e. is between the small scale and large scale coherence times. As such, the CPU 14 will act to update the dynamic access point cooperation and user assignment algorithm before the end of the current large-scale fading coherence time or T_{LSF} in order to improve the energy efficiency for the users in the next large-scale fading coherence time period and for the remainder of the current large-scale fading coherent time; the algorithm will then move to s528. If the answer at s518 is yes, then the algorithm has detected an anomaly wherein the anomaly length is greater than the large-scale fading coherence time (T_{LSF}) and as such the CPU will act to update the affected user to a different frequency band or group of access points in order to improve the user's energy efficiency in the future. The algorithm will then move to s528.

At s528 the CPU 14 makes a decision whether the current large scale fading coherence time period has elapsed as the iterative small scale fading sub-process runs up to the end of a large scale fading coherence time period. If the current large scale fading coherence time has elapsed or in other words it has reached the end of T_LSF, then the answer to the decision block is ‘Yes’ and the algorithm will loop back to s500 to restart the process for the next large scale fading coherence time. If the large scale fading coherence time has not elapsed then the answer to the decision block is ‘No’ and the algorithm will loop back to s512 so that the algorithm can continue to perform online anomaly detection for the active users within that large scale fading coherence time period.

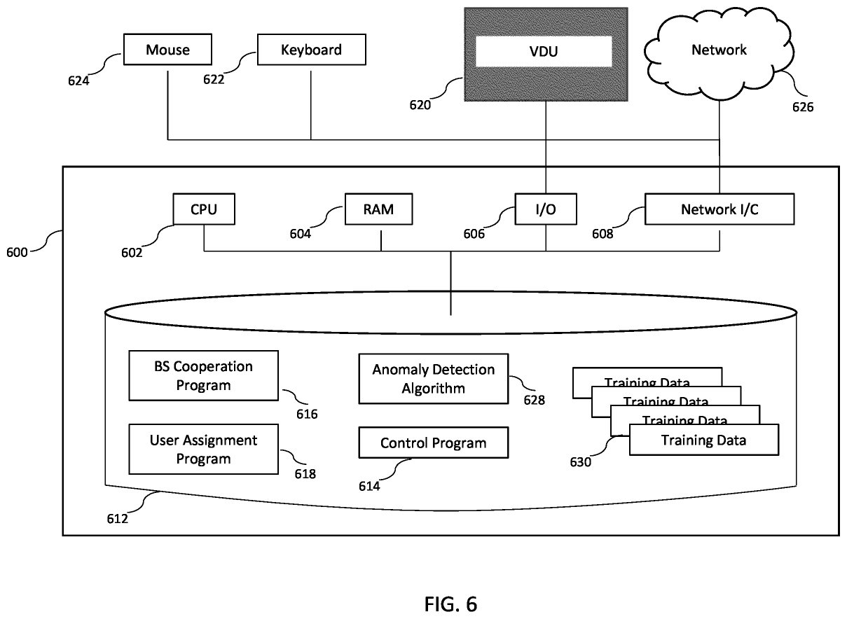

An example of a computer system used to perform embodiments of the present disclosure is shown in FIG. 6. The computer system is representative of the CPU 14 that is responsible for managing the cell-free network 1.

FIG. 6 is a block diagram illustrating an arrangement of a system according to an embodiment of the present disclosure. Some embodiments of the present disclosure are designed to run on a processor that would potentially be incorporated in a general purpose desktop or laptop computers. Therefore, according to an embodiment, a computing apparatus 600 is provided having a central processing unit (CPU) 602 (for example the same as the CPU (14) as present in FIG. 1), and random access memory (RAM) 604 into which data, program instructions, and the like can be stored and accessed by the CPU. The apparatus 600 may be provided with a visual display unit 620, and input peripherals in the form of a keyboard 622, and mouse 624. Keyboard 622, and mouse 624 communicate with the apparatus 600 via a input/output interface 608. Similarly, the VDU 620 is connected to the input/output interface, so as to cause it to display images under the control of CPU 602. The system also has a network communication link 626 connected via the Network I/C 608 for allow for communication between the CPU 602 and associated access points and users.

In this respect, apparatus 600 comprises a computer readable storage medium 612, such as a hard disk drive, writable CD or DVD drive, zip drive, solid state drive, USB drive or the like, upon which associated control programs and algorithms can be stored. Alternatively, the associated control programs and algorithms could be stored on a web-based platform, e.g. a database, and accessed via an appropriate network. The control programs and algorithms stored on the computer readable storage medium 612 when executed by the CPU 602, 14 cause the apparatus 600 to operate in accordance with some embodiments of the present disclosure.

In particular, a control program 614 is provided, which when executed by the CPU 602 provides overall control of the computing apparatus, and in particular provides a graphical interface on the display 620 and accepts user inputs using the keyboard 622 and mouse 624 by the input/output interface 606. The control interface program 614 also calls, when necessary, other programs to perform specific processing actions when required. For example, a access point cooperation program 616 and user assignment program 618 may be provided to complete and solve the LSF-based capacity maximization problem. A further anomaly detection algorithm 628 may be provided to complete the anomaly detection of the user energy efficiencies in the multi-variate time series data. A plurality of different anomaly detection algorithm 628 can be used to achieve the anomaly detection such as unsupervised collective point machine-learning algorithms, supervised machine-learning algorithms or simple thresholding. If the anomaly detection algorithm 628 is a machine-learning system which thus requires training a plurality of required training data 630 is also stored within the computer readable storage medium 612.

The operations of the access point program 616, user assignment program 618 and anomaly detection algorithm 628 are described in more detail below.

In operation, the computer system, either automatically or under the control of a user, launches the control program 614. The control program 614 is loaded into RAM 604 and is executed by the CPU 602. The system then launches the other programs as needed i.e., the access point cooperation program 616, the user assignment program 618 or the anomaly detection algorithm 628. The programs act (directly or indirectly) on data received via the network 626 and network I/C 608 to cause the cell free network and the access points and user terminals therein to operate in accordance with the method of FIG. 5, described in detail previously.

Thus, in the present embodiment the anomalous event detection method of the present embodiment is performed by the CPU 14, which acts a controller for the cell-free network. However, in other embodiments the processing required for the method may also be performed by other entities in the network, such as the user terminals or access points, or shared therebetween. Appropriate signaling between such entities to permit the necessary variables and other information required to operate the method would be known to the skilled person.

Various further modifications, whether by addition, substitution, or deletion will be apparent to the intended reader to provide further embodiments of the present disclosure, any and all of which are intended to be encompassed by the appended claims.

### REFERENCES

[1]G. Interdonato, E. Bjornson, H. Q. Ngo, P. Frenger, and E. G. Larsson, “Ubiquitous cell-free massive MIMO communications,” EURASIP 1022 J. Wireless Commun. Netw., pp. 1-13, August 2019.
[2]H. Q. Ngo, L. Tran, T. Q. Duong, M. Matthaiou, and E. G. Larsson, “On the total energy efficiency of cell-free Massive MIMO,” IEEE Trans. Green Commun. and Net., vol. 2, no. 1, pp. 25-39, March 2017.
[3]H. Q. Ngo, L.-N. Tran, T. Q. Duong, M. Matthaiou, and E. G. Larsson, “Energy efficiency optimization for cell-free massive MIMO,” in Proc. IEEE International Workshop on Signal Processing Advances in Wireless Communications (SPAWC), Hokkaido, Japan, July 2017.
[4]M. Bashar, K. Cumanan, A. G. Burr, H. Q. Ngo, E. G. Larsson, and P. Xiao, “On the energy efficiency of limited-backhaul cell-free massive MIMO,” IEEE ICC, May 2019.
[5]M. Bashar, K. Cumanan, A. G. Burr, H. Q. Ngo, E. G. Larsson, and P. Xiao, “On the energy efficiency of cell-free massive MIMO with optimal quantization,” IEEE Transactions on Green Communications and Networking, 2019.
[6]A. Adhikary, E. A. Safadi, M. Samimi, R. Wang, G. Caire, T. S. Rappaport, and A. F. Molisch, “Joint spatial division and multiplexing for mm-wave channels,” IEEE J. Sel. Areas Commun., vol. 32, no. 6, pp. 1239-1255, June 2014.
[7]A. B. Garcia, A. Conde, U. Mori, and J. A. Lozano. A review on outlier/anomaly detection in time series data. ACM Computing Surveys, 2020.
[8]K. Hundman, V. Constantinou, C. Laporte, I. Colwell, T. Soderstrom “Detecting Spacecraft Anomalies Using LSTMs and Nonparametric Dynamic Thresholding,” https://arxiv.org/pdf/1802.04431.pdf
[9]K. Ward, G. Dilillo, I. Eckley, and P. Fearnhead. Poisson-focus: An efficient online method for detecting count bursts with application to gamma ray burst detection. https://arxiv.org/pdf/2208.01494.pdf, page 1-36, 2022.
[10]J. Brownlee. A gentle introduction to Istm autoencoders. https://machinelearningmastery.com/Istm-autoencoders/, 2018.
[11]A. T. M. Fisch, I. A. Eckley, and P. Fearnhead. A linear time method for the detection of point and collective anomalies. https://arxiv.org/pdf/1806.01947.pdf, page 1-40, 2019.

1. A method for detecting an anomalous event in user energy efficiency in a cell-free wireless telecommunications network, the cell-free wireless telecommunications network comprising a plurality of access points configured to serve one or more users, the method comprising:
obtaining a transmission power for a user over a large-scale fading coherence time;
obtaining a time series of small-scale fading instantaneous energy efficiency values relating to a small-scale fading coherence time, wherein the small-scale fading coherence time is less than the large-scale fading coherence time such that multiple small-scale fading instantaneous energy efficiency values are contained in the time series per large-scale fading coherence time;
identifying one or more anomaly periods of anomalous instantaneous energy efficiency values within the time series of small-scale fading instantaneous energy efficiency values; and
causing a reconfiguration of the user within the cell-free wireless telecommunications network in dependence on identification of the one or more anomaly periods of anomalous instantaneous energy efficiency values.

2. The method according to claim 1, wherein the identification of the one or more anomaly periods further comprises:
identifying a sustained drop in user energy efficiency indicative of an anomalous event;
determining a length of the anomalous event; and
comparing the length of the anomalous event with the small-scale coherence time and the large-scale coherence time.

3. The method according to claim 2, wherein reconfiguration of the user comprises:
determining that the length of the anomalous event is greater than the small-scale coherence time but smaller than the large-scale coherence time; and
updating the user access point allocation to support the user with a different access point from the plurality of access points within the cell-free wireless telecommunications network.

4. The method according to claim 3, wherein the updating occurs within a large-scale coherence time period.

5. The method according to claim 2, wherein reconfiguration of the user comprises:
determining that the length of the anomalous event is greater than the large-scale fading coherence time and the small-scale fading coherence time; and
updating the user frequency allocation to support the user in a different frequency band.

6. The method according to claim 1, further comprising:
initializing the user at the start of each large-scale coherence time period, wherein the initializing further comprises allocating an access point and a frequency band to the user.

7. The method according to claim 1, wherein the small-scale fading energy efficiency values are based on the obtained transmission power.

8. The method according to claim 1, further comprising:
optimizing the capacity of the cell-free wireless telecommunications network using large-scale fading components.

9. The method according to claim 1, wherein obtaining the time series of small-scale fading instantaneous energy efficiency values further comprises monitoring the instantaneous energy efficiency of the user over the small-scale fading coherence time.

10. The method according to claim 1, wherein identifying the sustained drop in user energy efficiency indicative of an anomalous event is achieved using a sub-sequence anomaly detection technique.

11. The method according to claim 10, wherein the sub-sequence anomaly detection technique is a machine-learning algorithm which has been trained on a plurality of example sustained drops in user energy efficiency indicative of anomalous events.

12. The method as claimed in claim 1, performed for each user of a plurality of users.

13. A system for detecting anomalous events in user energy efficiency in a cell-free wireless telecommunications network having a plurality of users and access points, the system comprising:
a processor; and
a computer-readable medium having stored thereon computer executable instructions that when executed trigger the processor to:
calculate and fix a transmission power for a user using a large-scale fading components;
calculate an instantaneous energy efficiency of the user using the fixed transmission power and a small-scale fading component;
identify a sustained drop in user energy efficiency indicative of an anomalous event;
determine a length of the anomalous event; and
reconfigure the user based on the length of the anomalous event in comparison with a small-scale coherence time and a large-scale coherence time.

14. The system according to claim 13, wherein the processor has access to at least the following information:
the number of users, K, within the cell-free wireless telecommunications network;
the number of access points, M, within the cell-free wireless telecommunications network;
data indicative of the small-scale fading components;
data indicative of the large-scale fading components; and
the available frequency bands for communication within the cell-free wireless telecommunications network

15. The system according to claim 13, wherein the computer-readable medium has further stored thereon:
a sub-sequence anomaly detection technique that utilizes machine-learning techniques to identify sustained drops in user energy efficiency indicative of an anomalous event; and
a series of long time series data containing a plurality of example sustained drops in user energy efficiency indicative of anomalous events for use in training the sub-sequence anomaly detection technique.

16. A system for detecting anomalous events in user energy efficiency in a cell-free wireless telecommunications network having a plurality of users and access points, the system comprising:
a processor; and
a computer-readable medium having stored thereon computer executable instructions that when executed cause the processor to perform the method of claim 1.
